(19) United States
(12) Patent Application Publication
(10) Pub. No.: US 2012/0281065 A1
(43) Pub. Date: Nov. 8, 2012

(54) SYSTEM & METHOD FOR RENDERING & TRANSMISSION OF THREE DIMENSIONAL VIDEO AND AUDIO TO A USER

(76) Inventor: Benjamin P. Licht, Delray Beach, FL (US)

(21) Appl. No.: 13/102,574

(22) Filed: May 6, 2011

(51) Int. Cl. H04N 5/93; H04N 13/00

(52) U.S. Cl. 348/43; 386/278; 386/E05.003; 348/E13.002

(57) ABSTRACT

A dedicated server having a web application device that communicates with a user across a network transmitting a request for viewing a video style that is to be altered. The user selects a video style at his local computer. The application transmitting a choose request page asking to the user whether or not the user wants to upload or email required files and or parameters. A database of order, customer and style information that is updated by the web application device on the dedicated server wherein the database is updated by the web application device when a user uploads or emails the required files and parameters. An altered video rendered from the required files and or parameters. Required files and or parameters are assets of image, text, video or audio information. A 3D motion graphic video is rendered as a result. Changes via three levels: producer, director, and special FX.

### CROSS REFERENCE TO RELATED APPLICATIONS

N/A

### STATEMENT REGARDING FEDERALLY SPONSORED RESEARCH OR DEVELOPMENT

N/A

### COPYRIGHT NOTICE

A portion of the disclosure of this patent document contains material that is subject to copyright protection. The copyright owner has no objection to the facsimile reproduction by anyone of the patent document or patent disclosure as it appears in the United States Patent and Trademark Office patent file or records, but otherwise reserves all copyrights whatsoever.

### BACKGROUND

### FIELD OF THE INVENTION

Relating to improvements in the transmission of video and or audio technologies via communication networks. More specifically, relating to improvements in the purchasing, processing, rendering and transmission to a user.

The modern world has been greatly changed by the interconnectivity offered via the internet and mobile communication networks. The ubiquitous use of PDAs, cell phones and smart phones, as well as the ordinary desktop and portable computers has facilitated the transmission of a vast amount of audio and visual media to the end user. Using a centralized or decentralized network, hubs, routers and an assortment of data processing systems a user is able to purchase items from books to home apparel and much more. As an example, FIG. 1 illustrates how a network 100 provides audio 110, video 120 and data 130 content to a variety of end users 140. A user typically selects a hyperlink protocol to access the site of a desirable item and downloads it either through free access to the item or through purchasing the item(s) using a credit card or other third party payment processing system. However, these systems typically are limited to simply requesting the file download to a user's local computer; much more importantly they do not have the capability to customize downloadable video content. Thus, there needs to be a mechanism to overcome this deficiency.

### BRIEF SUMMARY OF THE INVENTION

A system for quickly and economically utilizing existing professional photograph and video production software comprising: a dedicated server having a web application device that communicates with a user across a network such that the user transmits a request for viewing a video style that is to be altered by the user. The user selects a video style at his local computer that is to be altered by the user. The web application device transmitting a choose request page asking to the user whether or not the user wants to upload or email required files and or parameters. A database of order, customer and style information that is updated by the web application device on the dedicated server wherein the database is updated by the web application device when a user uploads or emails the required files and parameters. An altered video rendered from the required files and or parameters.

A method for quickly and economically utilizing existing professional photograph and video production software comprising the steps of a user views video styles on a local computer from a dedicated server across a communication network; the user purchases one or more styles across said network wherein the purchased style(s) are loaded into a dedicated database server; as a result, a web application device emails information to a user requesting more information about various assets for purchased style(s) and also transmits links relevant to finishing an alteration of purchased style(s); also, the web application device posts a customer input page to the user's local computer inquiring as to a manner of providing required files and or parameters for completion of the purchase. A user browsing local files to find a required file if a user has chosen to upload files. A web application checking to see if the file a user chooses to upload when finishing the alteration of the purchased style(s) passes an upload file size check. Then repeating the same process until a user finds a correctly sized file or he or she exits manually out of the process. The web application device updating a local dedicated server database with uploaded file information. The web application device rendering a final video based upon uploaded file information. The web application device transmitting the rendered final video based upon uploaded file information to the user's local computer via the network. If emailing, a web application receiving files from user emails and registering these files in a database so as to finish the alteration of the purchased style(s) once all required files and or parameters are received. The web application device rendering a final video based upon emailed file and parameter information. The web application device transmitting the rendered final video based upon emailed file and parameter information to the user's local computer via the network. The various assets for purchased style(s) are from the group comprising: audio, photo, text, and video.

A dedicated web application server comprising hardware controlled by operating system software stored on the server; a software web application managing user changes and final rendering of a 3D motion graphic video for transmission across a network to a customer. User changes are from the group of: audio, photo, text and video. Further, user changes are submitted via three access levels from the group of producer, director, and special FX.

### BRIEF DESCRIPTION OF THE SEVERAL VIEWS OF THE DRAWINGS

FIG. 1 illustrates the prior art system of downloading audio and video content via a network connection.

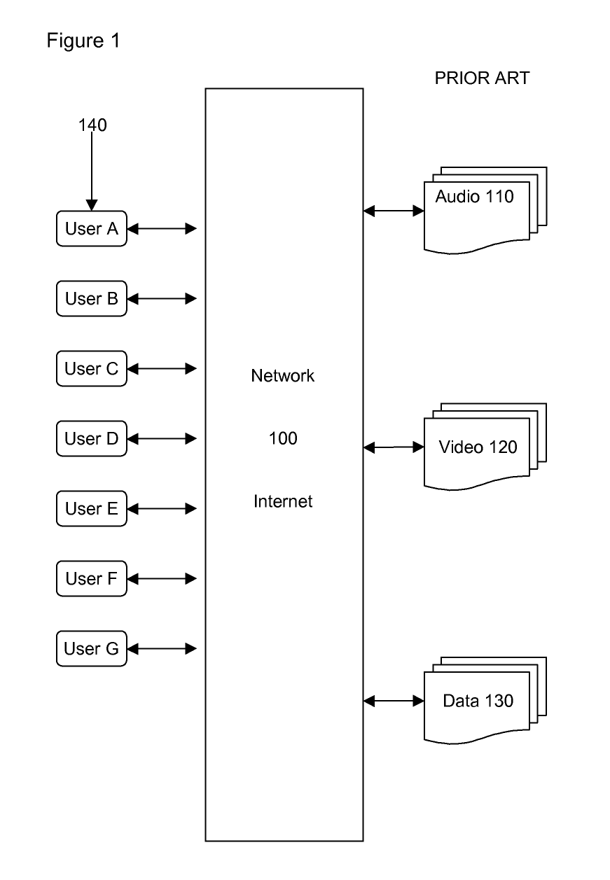

FIG. 2 illustrates the overall process by which a user may communicate a request for customizing professional photographic and or video proprietary software according to an embodiment.

FIG. 3 illustrates in greater detail the process by which a user may purchase, customize and receive the final photographic, audio and or video proprietary software.

FIG. 4 illustrates the process of uploading user assets to the dedicated server for further processing and rendering of the final product.

FIG. 5 illustrates the process of a user emailing needed assets to the dedicated server for further processing and rendering of the final product.

FIG. 6 illustrates how a user has customized a final product that is rendered and downloaded to a local computer through the use of inputted photographs, audio, text and the selection of a unique video style.

FIG. 7 illustrates the general structure of the hardware and software within which the embodiment may be practiced.

### DETAILED DESCRIPTION OF THE INVENTION

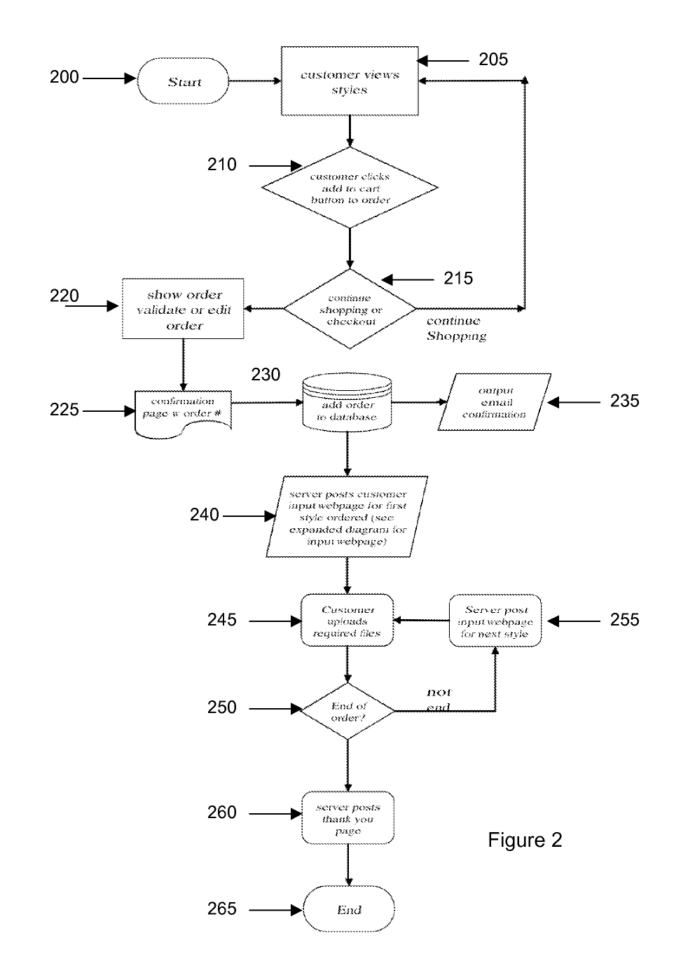

The following is a detailed description of the invention as regards to the cited FIGS. 2-7. In particular, what is taught is a system and method for quickly and economically utilizing existing professional photograph and video production software by taking proprietary designs and then breaking them down into their integral component parts. Once this has been accomplished the final rendering of the video and or photographic product is blended into a final usable video display which can be produced in many formats and easily reproduced if needed. The video output thus produced is sometimes called 3D Motion Graphics; it can be of DVD quality or HD quality.

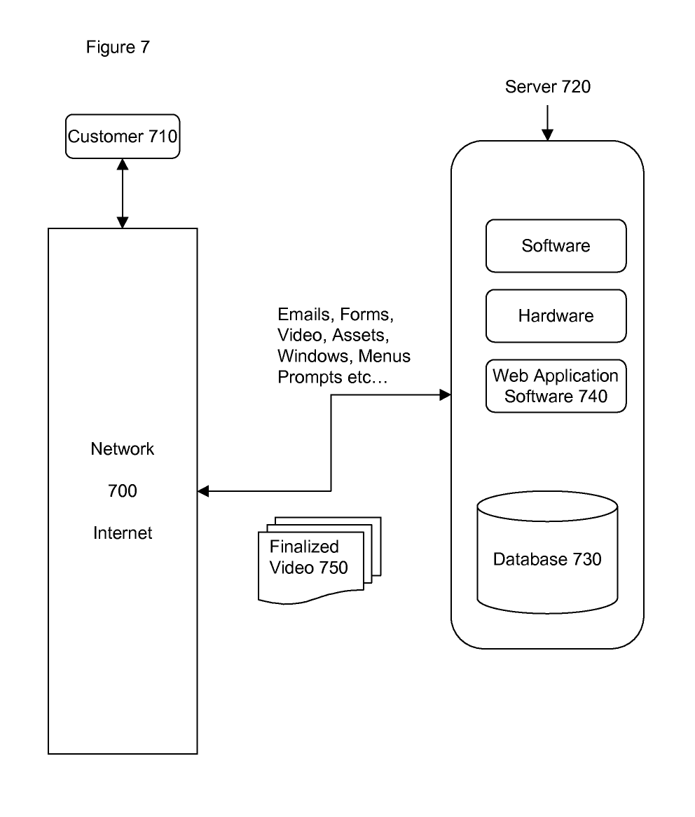

FIG. 2 illustrates the overall process by which a user may communicate a request for customizing professional photographic and or video proprietary software according to an embodiment. The process starts 200 with a customer communicating via a network (internet, telecom, network) such as that found in FIG. 7 to a server for review of a group of styles 205 that are stored locally on the aforementioned server. These styles are sent via the same network just mentioned to the user's local computer. Once a user has located a style suitable to his or her particular tastes, an order 210 is made through the ADD TO CART BUTTON. At this point the user has to decide 215 whether to continue shopping or whether to checkout. If the decision is made to continue to shop then the process will loop back to step 205 so that more video styles may be reviewed. However, if a decision has been made to checkout then the entire order is displayed 220 on the purchaser's local computer; here electronic payment processing or credit card information, user details, email address and similar information are gathered. Additionally, a button on the screen will provide an opportunity to confirm the order or whether or not to edit the order such as deleting it entirely or adding multiple copies of the item or changing the personal information of the buyer or deleting or adding more copies of other styles beyond the first one ordered.

Upon validation of the order a ‘Confirmation Page’ is displayed 225 on the user's local computer with the order number and other information relevant to the transaction. As a consequence of the previous step, the order details including personal user information, billing information, email address and similar items are added to a database 230 for processing. A confirmation email is sent to the user detailing the nature of the transaction, the specific charges and other relevant information directly related to the purchase; the email address 235 (this step may also be located graphically between steps 230 and 240) provided by the end user in step 220 is used in this step. Once the electronic payment processing has completed the customization of the video commences with the server transmitting via the network an input webpage detailing 240 the style being ordered. More particularly, the webpage illustrates to the purchaser those customizable traits specific to the first chosen style and offers a prompt, button, text entry box or similar graphical interface for entry of the location of the files to be uploaded for user selection as well as any customizable traits to be altered according to the purchaser's tastes. The traits are defined as assets like: audio, video, photo, text.

The customer uploads 245 any and all required files via the network to the server so as to facilitate final rendering by the dedicated server. Some of the file types that may be uploaded include: audio, video, text and image files. Next, a decision is made 250 as to whether or not the order has been completely processed and if so the dedicated server will post a ‘Thank You’ page 260 to the user's browser with or without order information and subsequently the process ends 265. However, in the event that the order has not been completed the server will continue the process by repeating the process of step 240 by posting at step 255 a customer input webpage. Again the webpage illustrates to the purchaser those customizable traits specific to the next chosen style and offers a prompt, button, text entry box or similar graphical interface for entry of the location of the files to be uploaded for user selection as well as any customizable traits to be altered according to the purchaser's tastes. The process repeats through steps 245 and 250 until there are no more styles in the order and then the system continues to steps 260 and 265 as described previously.

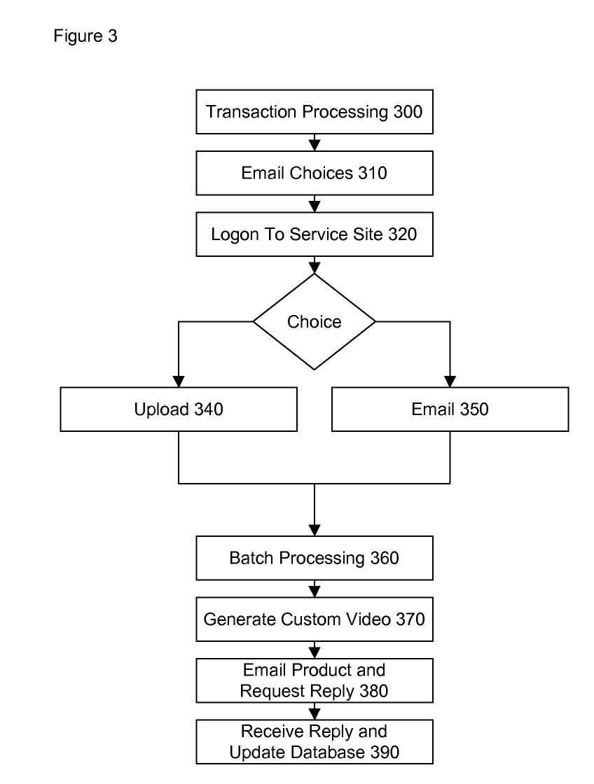

FIG. 3 illustrates in greater detail the process by which a user may purchase, customize and receive the final modified 3D Motion graphic including the modifications of text, photographic, audio and or video proprietary software included by the user. The transaction is processed 300 including the customer information, style(s), quantities and payment information as shown. Then, a web based application collocated on the server will email the customer 310 detailing the upload or email choices, information FAQ's regarding the business, transaction and electronic requirements including HOW TO video links to proceed forward with the process of customization; additionally, because of size constraints, various explanations are given as to the need to resize images so as to maintain bandwidth limits placed on the server. Included in this email are any necessary IDENTIFICATION and PASSWORDS necessary to facilitate the logging into the service center sub-site for customization. Once the user has reviewed all of the information provided in the email he or she utilizes the IDENTIFICATION and PASSWORD provided in the email to gain access 320 to the customization service center sub site.

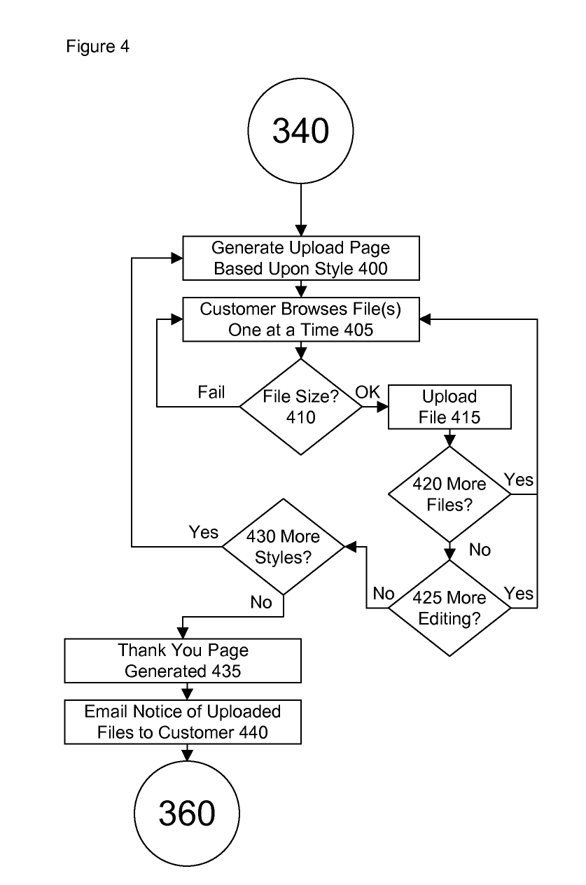

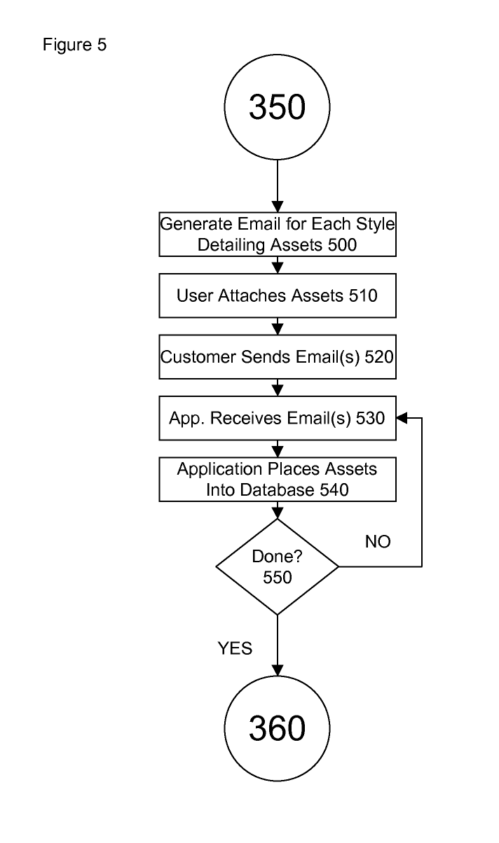

By logging into the sub site it is understood that access to the site is preserved only to paying customers and only for the purposes of inputting required asset files, selecting options and downloading of paid styles. Upon logging into the sub-site, two options are presented 330 in a web browser based prompt window that permits a choice between uploading the requested files or emailing the needed assets for completion of the project. When and if a user chooses to upload 340 the required files a subroutine is entered that is described in more detail in FIG. 4. On the other hand, if he or she has chosen to email 350 the required files then another subroutine is entered that is shown in more detail with respect to FIG. 5. In either case, the web application running on the server lists the order in a batch queue 360 for further processing by the server. Then, the web application generates a custom video 370 from the underlying base style and the uploaded or emailed assets (audio, photographic, video, text) that have been provided by the customer. It also emails (some people may choose to download the final product as their email servers may not accept such large email files) the finished custom video 380 formatted and modified with all of the user customization constraints; in this email, a notice to provide an indication as to the reception of the customized finished video product is also included. Once the purchaser returns a positive response 390 to the notice to provide an indication of the reception of the customized finished video product the customer database records are updated by the server control system and the process ends.

FIG. 4 illustrates the process of uploading user assets to the dedicated server for further processing and rendering of the final product. When uploading a file to a server it is necessary to ensure that bandwidth limits are not exceeded or the entire system may be crashed by a small number of users. In order to ensure that this is not the case, a file size limit is imposed on needed files that are to be uploaded according to the ordinary network based uploading process. The subroutine 340 of FIG. 3 begins in FIG. 4 with a web application generating an upload page 400 that is presented to the customer based upon a purchased style. Several parameters are presented to the user given the requirements of each style; these can include: producer, director, special FX and other general parameters unique to each style. Based upon these requirements, the purchaser browses 405 local user files one at a time for uploading via the network to the dedicated server. The application determines 410 whether or not the files being viewed meet the file size requirements. If they do not meet file size requirements then a ‘Too Large’ notice is generated to the user and a customer returns to the file browsing state 405.

If they do meet file size requirements, then the web application uploads the file 415 to a customer asset database location after prompting whether or not to proceed with the upload. Once the file is uploaded, the application determines 420 if that was the last file needed for the customization of the end product. If more files are needed then the process returns to the file browse state 405 so that a user can browse his local computer for the next necessary file one at a time. However, in the event that all the necessary files have been uploaded a user is prompted 425 with customer validation and edit needed buttons and or menus. If some editing is needed then a purchaser reviews the files on his computer again 405. Otherwise, the process continues to a Final Validation check to find out if another style 430 has been ordered. In the event that another style has been ordered, then the method subroutine restarts at step 400 whereby another upload page is generated based upon the particular style that has been purchased. The process continues as before through the previously described steps. However, if no other style has been bought then a ‘Thank You’ page is generated 435 and presented to a user via the network. An email notice is then sent 440 to the buyer showing that the required files have been uploaded successfully. Once the uploading of files has completed the process proceeds to step 360 in FIG. 3 whereby batch processing of the queue occurs.

FIG. 5 illustrates the process of a user emailing needed assets to the dedicated server for further processing and rendering of the final product. The subroutine 350 of FIG. 3 begins in FIG. 5 with the web application generating and sending an email (for each style) 500 based upon a purchased style including detailed parameters unique to each style. Several parameters are presented to the user given the requirements of each style; these can include: text, audio, video, image files, and other general parameters unique to each style. Based upon these requirements the purchaser 510 searches his local user files one at a time, attaches the files to a reply email and sends the reply email and attached file to the web application 520. Upon reception of the reply and attached files 530 the web application updates the customer database by placing assets 540 the attached files therein by order number. Once the database has been updated, the process run by the web server application checks to see 550 if all the necessary assets have been gathered. If that is the case then the application places the order into a queue for batch processing in step 360 of FIG. 3 and the process continues from there. On the other hand, if more file attachment assets are needed for each style then the process will wait to receive an email as in step 530.

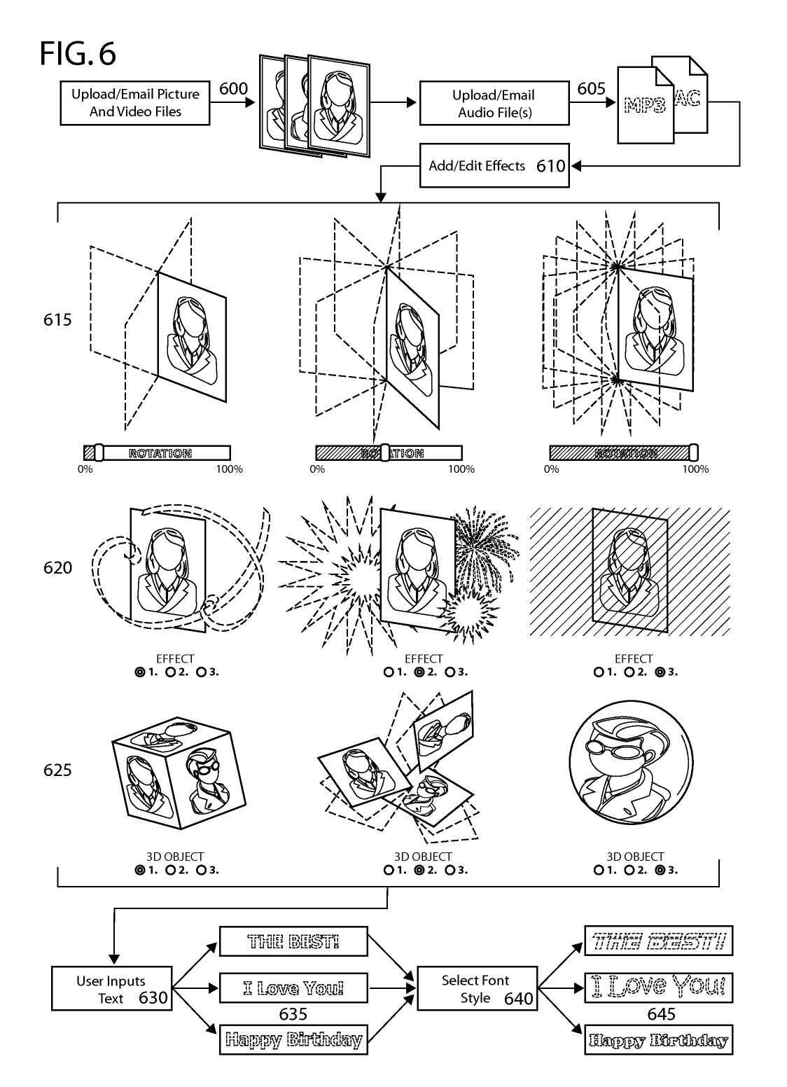

FIG. 6 illustrates how a user has customized a final product that is rendered and downloaded to a local computer through the use of inputted photographs, audio, text and the selection of a unique video style. Many different types of parameters are presented to the user given the requirements of each style; these can include but are not limited to: producer, director, special FX and other general parameters unique to each style. When these styles are selected, processed by the web application and finally rendered at the dedicated server they produce a video that can be played by a suitable player software which is common to modern computers and cell phones.

FIG. 7 illustrates the overall system disclosed in an embodiment herein. A network 700 permits communication of various data including purchasing information, video, audio, text, image, email, customer 710 prompts and replies from and to the dedicated web server 720. This dedicated server 720 houses software and hardware within which the embodiment may be realized. It controls database 730 containing customer information, order information including the styles and related assets needed and acquired from the user. Additionally it stores a web software application 740 controlling the overall process. It is this application that processes orders, generates windows of information for a user's local browser after transmission across the network 700, sends and receives emails, makes any confirmations, validations and receives emailed stylistic attachments. It also renders the final customized video 750 for transmission across the network 700 and ensures the integrity of all database 730 records.

Also contemplated in this embodiment are several levels of access; these permit the use of different types of services provided by the dedicated server 720 and web software application 740. In particular, the system provides for an increasing variety of choices available to more capable users as follows:
1. Producer—quick, easy and simple.
2. Director—ability to choose region of interest in pictures & videos; ability to crop (scale) pictures & videos.
3. Special FX—ability to choose backgrounds and choose from differing effects (possibly cartoon versions of pictures, high contrast renditions, etc.).

Finally, the novelties described herein are directed to various video graphics playable on a computer or cell phone. More particularly, the application taught herein is capable of encapsulating the various assets or components to produce the final resulting rendered video. The system is generally producing what is known as 3D Motion Graphics and the final product can be of DVD quality or even HD videos for additional cost. The invention has thus been described in such clear and precise terms as to enable one of ordinary skill in the art to understand its fundamental principles.

I claim:

1. A system for quickly and economically utilizing existing professional photograph and video production software comprising:
a dedicated server having a
web application device that communicates with a user across
a network such that the user transmits a request for viewing a video style that is to be altered by the user.

2. The system of claim 1, further comprising:
the user at his local computer selecting a video style to be altered by the user.

3. The system of claim 2, further comprising:
the web application device transmitting a choose request page asking to the user whether or not the user wants to upload or email required files and or parameters.

4. The system of claim 3, further comprising:
a database of order, customer and style information that is updated by the web application device on the dedicated server wherein the database is updated by the web application device when a user uploads or emails the required files and parameters.

5. The system of claim 4, further comprising:
an altered video rendered from the required files and or parameters.

6. The system of claim 2, further comprising:
an altered video rendered from the required files and or parameters.

7. A method for quickly and economically utilizing existing professional photograph and video production software comprising the steps of:
a user views video styles on a local computer from a dedicated server across a communication network;
the user purchases one or more styles across said network wherein the purchased style(s) are loaded into a dedicated database server; as a result,
a web application device emails information to a user requesting more information about various assets for purchased style(s) and also transmits links relevant to finishing an alteration of purchased style(s); also,
the web application device posts a customer input page to the user's local computer inquiring as to a manner of providing required files and or parameters for completion of the purchase.

8. The method of claim 7 further comprising the step of:
a user browsing local files to find a required file if a user has chosen to upload files.

9. The method of claim 8, further comprising the step of:
a web application checking to see if the file a user chooses to upload when finishing the alteration of the purchased style(s) passes an upload file size check.

10. The method of claim 9, further comprising the step of:
repeating the same process until a user finds a correctly sized file or he exits manually out of the process.

11. The method of claim 10, further comprising the step of:
the web application device updating a local dedicated server database with uploaded file information.

12. The method of claim 11, further comprising the step of:
the web application device rendering a final video based upon uploaded file information.

13. The method of claim 12, further comprising the step of:
the web application device transmitting the rendered final video based upon uploaded file information to the user's local computer via the network.

14. The method of claim 7, further comprising the step of:
a web application receiving files from user emails and registering these files in a database so as to finish the alteration of the purchased style(s) once all required files and or parameters are received.

15. The method of claim 14, further comprising the step of:
the web application device rendering a final video based upon emailed file and parameter information.

16. The method of claim 15, further comprising the step of:
the web application device transmitting the rendered final video based upon emailed file and parameter information to the user's local computer via the network.

17. The method of claim 7, wherein the various assets for purchased style(s) are from the group comprising: audio, photo, text, and video.

18. A dedicated web application server comprising:
hardware controlled by
operating system software stored on the server;
a software web application managing user changes and final rendering of a 3D motion graphic video for transmission across a network to a customer.

19. The dedicated web application server of claim 18, wherein user changes are from the group of: audio, photo, text and video.

20. The dedicated web application server of claim 18, wherein user changes are submitted via three access levels from the group of producer, director, and special FX.
